(19) United States
(12) Patent Application Publication
(10) Pub. No.: US 2021/0328655 A1
(43) Pub. Date: Oct. 21, 2021

(54) PORTABLE SHORTWAVE TRANSCEIVER HOTSPOT

(71) Applicant: Kelsey L Bruso, Eagan, MN (US)

(72) Inventor: Kelsey L Bruso, Eagan, MN (US)

(73) Assignee: Unisys Corporation, Blue Bell, PA (US)

(21) Appl. No.: 16/852,789

(22) Filed: Apr. 20, 2020

(51) Int. Cl. H04B 7/155; H04W 12/00

(52) U.S. Cl. CPC H04B 7/155; H04W 88/04; H04W 12/001

(57) ABSTRACT

A transceiver includes a computing device having shortwave TCP/IP and hotspot capabilities enabling the computing device to communicate via shortwaves with a base station connected to the Internet and to connect to user devices. An user device can use the computing device to communicate over the Internet via shortwaves on an existing Ham Radio Network. A system for establishing communications between an user device and the Internet includes a shortwave base station have TCP/IP capabilities and connected to the Internet. The system also includes an user device and a computing device having shortwave TCP/IP and hotspot capabilities enabling the computing device to communicate via shortwaves with the base station and to connect to the user device. The user device can use the computing device to communicate over the Internet via shortwaves on an existing Ham Radio Network.

### FIELD OF THE DISCLOSURE

The present application relates generally to a portable shortwave transceiver hotspot.

### BACKGROUND

One of the challenges in disaster situations, such as earthquakes, fire, hurricane, etc. is establishing effective communication for internet and messaging. In such situations, standard community infrastructure, such as cell towers, electricity, phone lines, etc. may be out of service for some time period. In the period immediately following an emergency, the first critical need is to establish communication with on-the-ground first responders, police, and others critical to assessing immediate needs. ATMs, gas stations and point of sale devices also need effective communication to function. Therefore, improvements are desirable.

### SUMMARY

In a first aspect of the present invention, a transceiver includes a computing device having shortwave TCP/IP and hotspot capabilities enabling the computing device to communicate via shortwaves with a base station connected to the Internet and to connect to user devices. An user device can use the computing device to communicate over the Internet via shortwaves on an existing Ham Radio Network.

In a second aspect of the present invention, a system for establishing communications between an user device and the Internet includes a shortwave base station having TCP/IP capabilities and connected to the Internet. The system also includes an user device and a computing device having shortwave TCP/IP and hotspot capabilities enabling the computing device to communicate via shortwaves with the base station and to connect to the user device. The user device can use the computing device to communicate over the Internet via shortwaves on an existing Ham Radio Network.

In a third aspect of the present invention, a computer implemented method of establishing communications between an user device and the Internet, the method comprising: establishing, by a processor of a portable shortwave TCP/IP transceiver, communication with a base station via shortwaves; and establishing, by a processor of an user device, communication with the portable shortwave TCP/IP transceiver. A user of a mobile device is able to use a portable shortwave TCP/IP transceiver to communicate over the Internet via shortwaves on an existing Ham Radio Network.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE FIGURES

For a more complete understanding of the disclosed system and methods, reference is now made to the following descriptions taken in conjunction with the accompanying drawings.

FIG. 1 is a block diagram illustrating an encrypted enclave of virtual machines organized into communities-of-interest, according to one embodiment of the present invention;

FIG. 2 is a block diagram illustrating a network implementing communities-of-interest, according to one embodiment of the present invention;

FIG. 3 is a block diagram illustrating an enclave included in the network of FIG. 2;

FIG. 4 is a schematic diagram of a system for quickly establishing communications, according to one example embodiment of the present invention;

FIG. 5 is a flow diagram of a method of establishing communications, according to one example embodiment of the present invention;

FIG. 6 is a block diagram illustrating a computer network, according to one example embodiment of the present invention; and

FIG. 7 is a block diagram illustrating a computer system, according to one example embodiment of the present invention.

### DETAILED DESCRIPTION

Ham Radio uses a variety of frequencies across the radio spectrum for communications. During daylight, 15 to 27 MHz is used most for long-distance communications, while at night 1.6 to 15 MHz is used. These bands are often called short-wave bands. Unlike frequencies used by FM radio stations and TV stations, which are line-of-sight and therefore limited to 40 or 50 miles, short-waves are reflected or refracted from a layer of electrically charged atoms in the atmosphere called the ionosphere from the transmitter to the receiver's antenna. Short-waves are capable of extremely long distance transmission. The higher the frequency is, the shorter the wavelength is.

The Amateur Radio Network is very large and dispersed throughout the world with over two million amateur radio stations, including over eight hundred thousand in the Americas. An amateur radio station is a radio station designed to provide radio communications in the amateur radio service for an amateur radio operator. These operators build and operate several types of amateur radio stations, including fixed ground stations, mobile stations, space stations and temporary field stations. Each of these is equipped with a transceiver and one or more antennas. There are also repeater stations that extend the range of communications for other stations. A repeater uses a receiver tuned to one radio frequency and a transmitter tuned to another radio frequency. If a repeater station is in a favorable location, such as on a tall tower, the top of a tall building or on a mountaintop, stations that otherwise would not be able to communicate with each other can each use the repeater and establish two-way communications. Repeater stations generally operate under automatic control and are freely available.

Natural disasters like hurricanes or tornadoes disrupt normal telephone, Internet and cell phone systems hampering normal communications. The Ham Radio Network is more reliable because of its distance capabilities and because needed infrastructure is less. Ham Radio operators normally pitch in to help with emergency communications by relaying voice messages and or broadcasting warnings. The present disclosure leverages this existing Amateur Radio Relay Network, or Ham Radio, for TCP/IP connections and uses a portable shortwave transceiver that also serves as a Wifi hotspot. This transceiver will facilitate needed communications until the normal systems can be repaired for brought back on line.

The portable transceiver can be easily carried in a backpack or satchel and deployed in the filed at the point of need. In the period immediately following an emergency, the first critical need is to establish communication with on-the-ground first responders, police and others critical to assessing immediate needs.

The advantage of shortwave is that it carries effectively over great distance, unlike Wifi, cellular or Lorawan connections. The disadvantage is latency. However, having a connection with latency is still preferable to having no connection at all until standard infrastructure can be rebuilt or repaired and returned to service.

A challenge with using shortwave is that it contains not one, but two broadcast mechanisms that give eavesdroppers ample opportunity to intercept or interfere with a message being transmitted. Stealth enterprise security solution form Unisys Corporation of Blue Bell, Pa. can be used to implement features of the present disclosure. Stealth can be used to protect the end to end messages and make the endpoints go dark on the Internet. As with other Stealth applications, not all endpoints require Stealth protection.

Stealth reduces attack surfaces in an environment by creating dynamic, identity-driven microsegments called communities-of-interest. Micro segmentation is a security strategy that segments a network into smaller elements and manages them with IT security policies. By establishing secure community-of-interest, Stealth separates trusted systems, users and data from the untrusted. It further reduces attack surfaces by encrypting all communication between Stealth protected assets and cloaking the assets from unauthorized users. Micro segmentation divides a physical network into multiple logical micro-segments. Only the resources within the micro segment can see and access one another.

For example, virtual machines executing on one or more servers may each be assigned one or more communities-of-interest. The communities-of-interest may allow an administrator to create logical organizations of virtual machines. A community-of-interest may be defined by a role of the virtual machines in the community-of-interest.

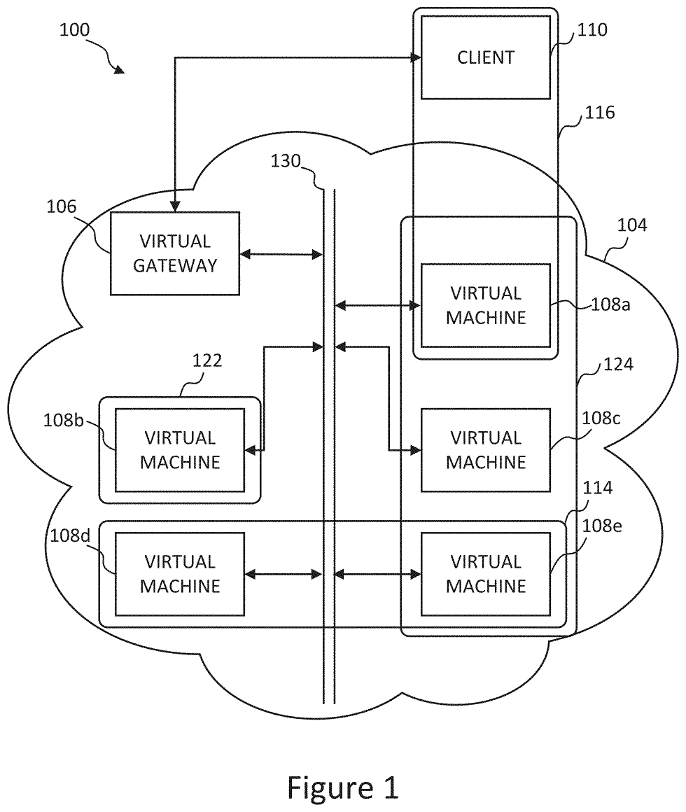

Messages or communications within a community-of-interest are encrypted with a key corresponding to the community-of-interest. In this fashion, messages or communications are cryptographically isolated. FIG. 1 is a block diagram illustrating an encrypted enclave of virtual machines organized into communities-of-interest according to one example embodiment of the present disclosure. A network 100 may include a network bus 130 serving an enclave 104. The bus 130 may couple virtual machines 108a-e within the enclave 104. Each of the virtual machines 108a-e may communicate through encrypted communications carried on the bus 130. A virtual gateway 106 may be coupled to the bus 130 to provide communications from the enclave 104 to external devices, such as a client 110 and/or other public networks, such as the Internet. The client 110 may be a remoted device, such as a personal computer or mobile device. The client 110 may be connected to the virtual gateway 106 through a secured tunnel, such that the communications between the client 110 and the virtual gateway 106 are encrypted similar to the encrypted communications on the bus 130.

The virtual machines 108a-e may be assigned to one or more communities-of-interest. For example, the virtual machines 108a, 108c, and 108e may be assigned to community-of-interest 124. Virtual machines 108d and 108e may be assigned to community-of-interest 114. And, virtual machine 108b may be assigned to community-of-interest 122. And, the virtual machine 108a and the client 110 may be assigned community-of-interest 116.

A virtual machine 108e may be instructed to transmit a message to the virtual machine 108a. For example, software executing on the virtual machine 108e may request data from a database server executing on the virtual machine 108e may request data from a database server executing on the virtual machine 108a. When the virtual machine 108e receives the message destined for the virtual machine 108a, the virtual machine 108e may identify a community-of-interest in common between virtual machine 108e and virtual machine 108a. The community-of-interest 124 may be identified and a key associated with community-of-interest 124 may be used to encrypt the message.

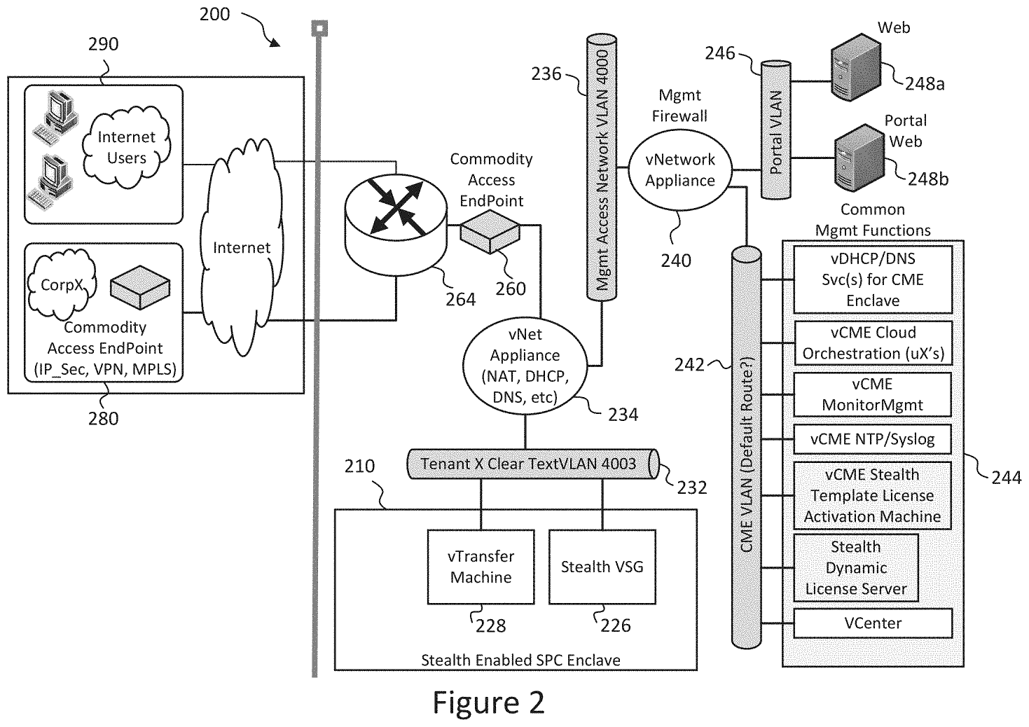

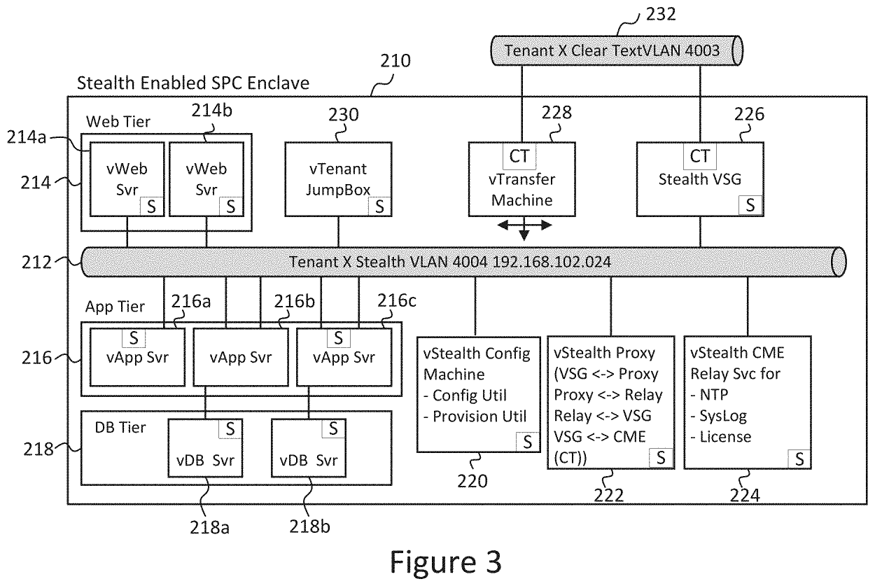

The community-of-interest organization of virtual machines may be implemented in a computer network to provide cryptographic isolation of virtual machines. FIGS. 2 and 3 are block diagrams illustrating a network implementing communities-of-interest according to one embodiment of the disclosure. A network 200 may include an enclave 210. According to one embodiment, the enclave 210 may belong to a single tenant of the network 200. In other embodiments, the enclave 210 may be shared between tenants.

Communities-of-interest may be configured for a web tier 214, an application tier 216, and a database tier 218. The web tier 214 may include a number of web servers 214a-b, the application tier 216 may include a number of application servers 216a-c, and the database tier 218 may include a number of database servers 218a-b. Each of the servers 214a-b, 216a-c, and 218a-b may be a virtual server executing within a virtual machine. Additional communities-of-interest may be defined for infrastructure functions, such as an administrator community-of-interest key COI, a relay COI, an application tier management COI, a database tier management COI, and a jumpbox management COI. The enclave 210 may also include a jumpbox 230, a transfer machine 228, a virtual gateway 226, a relay 224, a proxy 222, and a configuration device 220, which may also be executing in virtual machines.

Membership of the virtual machines in individual COIs are shown as numbered circles. Each circle may represent a different COI, such as the web tier COI. For example, a web tier COI may include the servers 214a-b, the jumpbox 230, and the virtual gateway 226. According to one embodiment, only virtual machines that share a common COI may communicate. When a first virtual machine initiates communication with a second virtual machine, the first virtual machine may search for a common COI between the first and the second virtual machine. If found, a cryptographic session key may be created that is encrypted with a key associated with the common COI. Thus, only a virtual machine that shares the COI key may decrypt the session key. All communication between the two virtual machines may be encrypted and decrypted with the session key. Messages within the enclave 210 may be isolated from the rest of the network 200, because the messages are encrypted with keys that are not available to the rest of the network 200.

For example, a web server virtual machine 214a may be able to communicate with another web server virtual machine 214b, because the virtual machines 214a-b have the web tier COI in common. They may also be able to communicate with application server virtual machines 216a-c, because the machines 214a-b and 216a-c have the application tier COI in common.

Each of the devices within the enclave 210 may be coupled to a bus 212. When a device within the enclave 210 communicates with devices outside the enclave 210, then messages may be handled by the virtual gateway 226, which may be coupled to an unencrypted network 232. According to one embodiment, the virtual gateway 226 may encrypt and/or decrypt messages between the enclave 210 and the unencrypted network 232. The network 232 may couple the enclave 210 to other network appliances 234, such as network address translation (NAT) devices, dynamic host control protocol (DHCP) devices, domain name service (DNS) devices, and the like. The other network appliances 234 may also be executing in virtual machines.

Access to the enclave 210 may be controlled by the virtual gateway 226. Messages passing through the gateway 226 from the unencrypted, or clear-text, network 222 to the enclave 210 may be encrypted and messages in the other direction may be decrypted by the gateway 226. According to one embodiment, messages within the enclave 210 may only be transmitted to a virtual machine that has a COI in common with the gateway 226. Furthermore, the gateway 226 may be configured to filter messages for a COI. The filter may allow an administrator to restrict access based on a message's source and/or destination address and/or port. The enclave 210 may also be isolated from other enclaves (not shown) in the network 200, because only a virtual machine having a common COI with the gateway 226 may communicate outside of the enclave 210.

For example, the web servers 214a-b may be able to communicate through the gateway 226, because the web servers 214a-b share the web tier COI with the gateway 226. In another example, the application servers 216a-c and the database servers 218a-b may have restricted access through the gateway 226, because the gateway 226 may filter messages transmitted in the application COI and the database COI to only provide access to management devices 244.

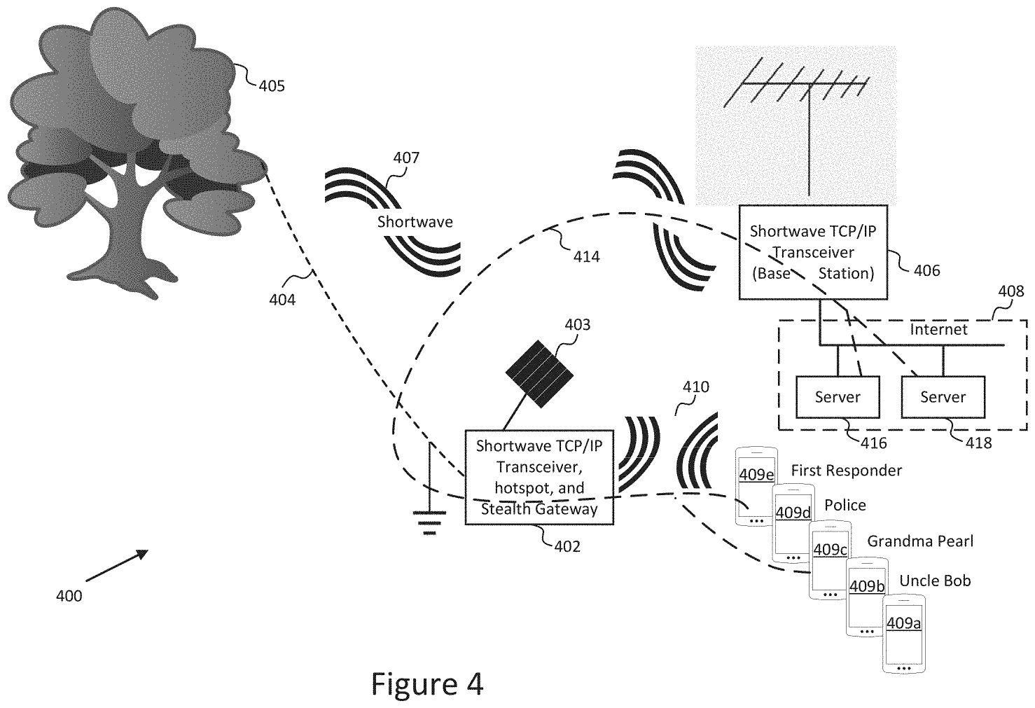

FIG. 4 is a schematic overview of a system 400 for quickly establishing communications. The system 400 includes a portable shortwave transceiver hotspot 402. This transceiver 402 can be a small computer device, such as a Raspberry Pi®. The transceiver can be connected to a charger 403, such as a solar charger. To improve communication range, the transceiver 402 can also be connected to an antenna 404. Preferably, the antenna 404 is connected to a tree 405, or other elevated position, building, balcony, telephone pole, etc. The transceiver 402 is a shortwave TCP/IP transceiver, hotspot and Stealth Gateway. The transceiver 402 communicates with a base station 406 via shortwaves 407. The base station 406 (including an antenna) is a shortwave TCP/IP transceiver that is connected to the Internet 408. In one embodiment, user devices 409a-e communicate with the transceiver 402 via Wifi 410. In other embodiments, the Bluetooth, Near Field communication (NFC), other wireless protocol or a hard wired connection could be used. The user devices 409a-e can be any device that can attach to the transceiver 402, such as laptop devices, IoT devices, mobile devices, iPad and other tablet device or desktop devices.

In one example, mobile devices 409e, 409d and 409c might be used by first responders while mobile devices 409a and 409b are used by others. The mobile devices 409c, 409d and 409e (mobile device, tablet, laptop, etc.) might use Stealth to protect their communications whereas others do not. Thus a community-of-interest 414 might include the mobile devices 409c, 409d, 409e, the transceiver 402, the base station 405 and servers 416, 418. The mobile devices 409c, 409d, 409e would have Stealth mobile installed on them.

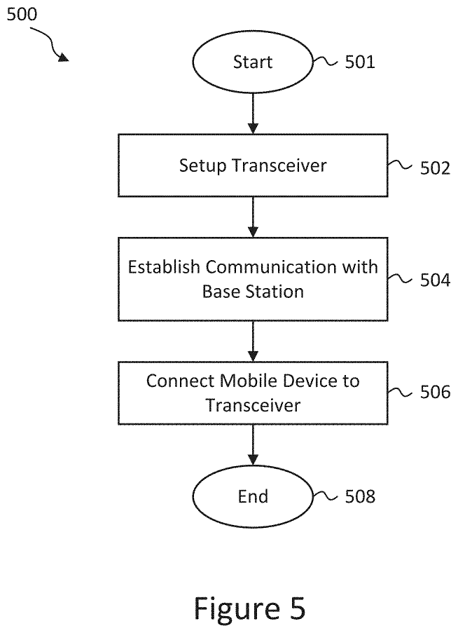

FIG. 5 is a flow diagram of a method of establishing communication 500 using a portable transceiver 402. In use, during an outage of normal communication means, at 502, a first responder sets up the transceiver 402 and connects it to the charger 403 and extends the antenna 404 to an elevated position 405. At 504, the transceiver 402 establishes communication via shortwaves 407 with a base station 405, which is connected to the Internet 408. At 506, the first responder connects its mobile device 409e to the transceiver 402 via Wifi 410. At 508, the first responder is able to use its mobile device 409e to communicate over the Internet 408 through the transceiver 402 and base station 405.

The above described system and methods could be used for other purposes as well. For example, ATMs, gas stations, and other point of sale situations in electronic commerce could be connected to the Internet. People could be connected to the Internet for secure communication, on-line banking or other Internet needs. People, such as hikers, campers, etc., in remote locations without standard phone or Internet services can be connected to the Internet using the portable transceiver.

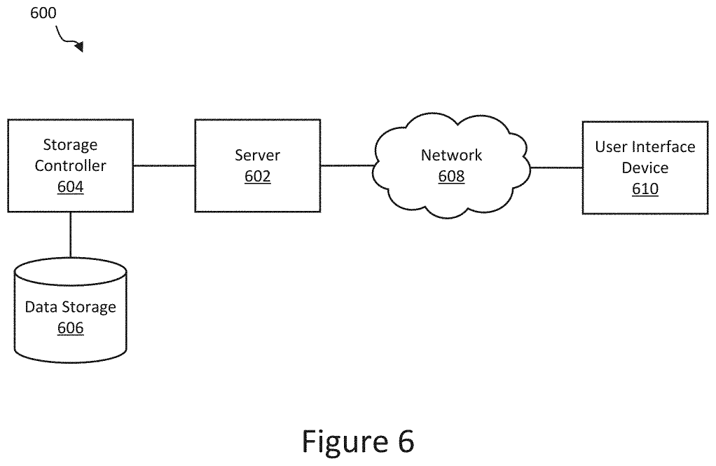

FIG. 6 illustrates one embodiment of a system 600 for an information system, which may host virtual machines. The system 600 may include a server 602, a data storage device 606, a network 608, and a user interface device 610. The server 602 may be a dedicated server or one server in a cloud computing system. The server 602 may also be a hypervisor-based system executing one or more guest partitions. The user interface device 610 may be, for example, a mobile device operated by a tenant administrator. In a further embodiment, the system 600 may include a storage controller 604, or storage server configured to manage data communications between the data storage device 606 and the server 602 or other components in communication with the network 608. In an alternative embodiment, the storage controller 604 may be coupled to the network 608.

In one embodiment, the user interface device 610 is referred to broadly and is intended to encompass a suitable processor-based device such as a desktop computer, a laptop computer, a personal digital assistant (PDA) or tablet computer, a smartphone or other a mobile communication device having access to the network 608. The user interface device 610 may be used to access a web service executing on the server 602. When the device 610 is a mobile device, sensors (not shown), such as a camera or accelerometer, may be embedded in the device 610. When the device 610 is a desktop computer the sensors may be embedded in an attachment (not shown) to the device 610. In a further embodiment, the user interface device 610 may access the Internet or other wide area or local area network to access a web application or web service hosted by the server 602 and provide a user interface for enabling a user to enter or receive information.

The network 608 may facilitate communications of data, such as dynamic license request messages, between the server 602 and the user interface device 610. The network 608 may include any type of communications network including, but not limited to, a direct PC-to-PC connection, a local area network (LAN), a wide area network (WAN), a modem-to-modern connection, the Internet, a combination of the above, or any other communications network now known or later developed within the networking arts which permits two or more computers to communicate.

In one embodiment, the user interface device 610 accesses the server 602 through an intermediate sever (not shown). For example, in a cloud application the user interface device 610 may access an application server. The application server may fulfill requests from the user interface device 610 by accessing a database management system (DBMS). In this embodiment, the user interface device 610 may be a computer or phone executing a Java application making requests to a JBOSS server executing on a Linux server, which fulfills the requests by accessing a relational database management system (RDMS) on a mainframe server.

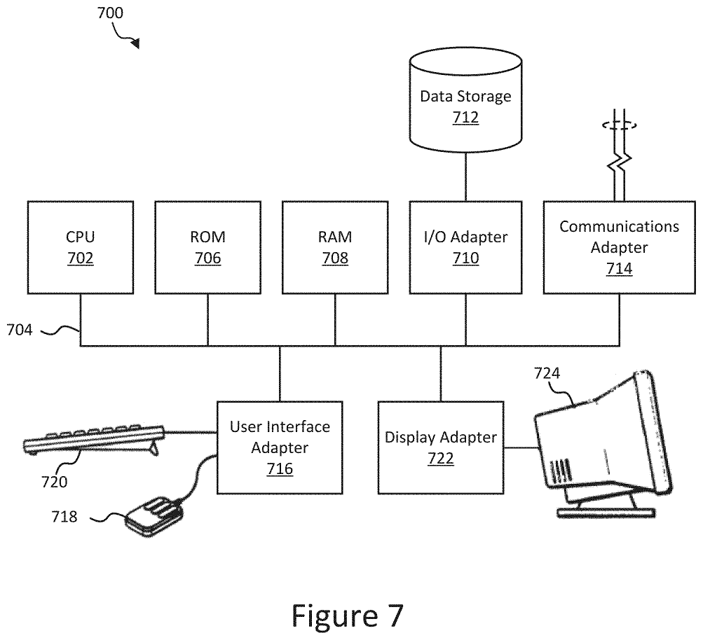

FIG. 7 illustrates a computer system 700 adapted according to certain embodiments of the server 602 and/or the user interface device 710. The central processing unit (“CPU”) 702 is coupled to the system bus 704. The CPU 702 may be a general purpose CPU or microprocessor, graphics processing unit (“GPU”), and/or microcontroller. The present embodiments are not restricted by the architecture of the CPU 702 so long as the CPU 702, whether directly or indirectly, supports the operations as described herein. The CPU 702 may execute the various logical instructions according to the present embodiments.

The computer system 700 also may include random access memory (RAM) 708, which may be synchronous RAM (SRAM), dynamic RAM (DRAM), synchronous dynamic RAM (SDRAM), or the like. The computer system 700 may utilize RAM 708 to store the various data structures used by a software application. The computer system 700 may also include read only memory (ROM) 706 which may be PROM, EPROM, EEPROM, optical storage, or the like. The ROM may store configuration information for booting the computer system 700. The RAM 708 and the ROM 706 hold user and system data, and both the RAM 708 and the ROM 706 may be randomly accessed.

The computer system 700 may also include an input/output (I/O) adapter 710, a communications adapter 714, a user interface adapter 716, and a display adapter 722. The I/O adapter 710 and/or the user interface adapter 716 may, in certain embodiments, enable a user to interact with the computer system 700. In a further embodiment, the display adapter 722 may display a graphical user interface (GUI) associated with a software or web-based application on a display device 724, such as a monitor or touch screen.

The I/O adapter 710 may couple one or more storage devices 712, such as one or more of a hard drive, a solid state storage device, a flash drive, a compact disc (CD) drive, a floppy disk drive, and a tape drive, to the computer system 700. According to one embodiment, the data storage 712 may be a separate server coupled to the computer system 700 through a network connection to the I/O adapter 710. The communications adapter 714 may be adapted to couple the computer system 700 to the network 708, which may be one or more of a LAN, WAN, and/or the Internet. The communications adapter 714 may also be adapted to couple the computer system 700 to other networks such as a global positioning system (GPS) or a Bluetooth network. The user interface adapter 716 couples user input devices, such as a keyboard 720, a pointing device 718, and/or a touch screen (not shown) to the computer system 700. The keyboard 720 may be an on-screen keyboard displayed on a touch panel. Additional devices (not shown) such as a camera, microphone, video camera, accelerometer, compass, and or gyroscope may be coupled to the user interface adapter 716. The display adapter 722 may be driven by the CPU 702 to control the display on the display device 724. Any of the devices 702-722 may be physical and/or logical.

The applications of the present disclosure are not limited to the architecture of computer system 700. Rather the computer system 700 is provided as an example of one type of computing device that may be adapted to perform the functions of a server 602 and/or the user interface device 610. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 700 may be virtualized for access by multiple users and/or applications.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A transceiver comprising:
a computing device having shortwave TCP/IP capability for communicating with a shortwave base station and WIFI TCP/IP capability for communicating with a user device;
wherein the computing device can receive user communications from the user device via WIFI TCP/IP capability and transmit the user communications to the shortwave base station via shortwave TCP/IP such that the user device can use the computing device to communicate via shortwaves on an existing Ham Radio Network.

2. The transceiver according to claim 1, wherein the user device is a mobile device.

3. The transceiver according to claim 2, wherein the base station is connected to the Internet.

4. The transceiver according to claim 1, further comprising a charger and an antenna connected to the computing device.

5. The transceiver according to claim 1, wherein the computing device and the base station have security software loaded on them to enable a community-of-interest to include the base station and the computing device.

6. The transceiver according to claim 5, wherein the user device has security software loaded on it to enable it to be a part of the community-of-interest.

7. The transceiver according to claim 5, wherein the security software is Stealth.

8. A system for establishing communications between aft user device and the Internet, the system comprising:
a shortwave base station having TCP/IP capabilities and connected to the Internet;
a user device;
a computing device having shortwave TCP/IP capability for communicating with a shortwave base station and WIFI TCP/IP capability for communicating with a user device;
wherein the computing device can receive communications from the user device via WIFI TCP/IP capability and transmit the communications via shortwave TCP/IP to the base station such that the user device can use the computing device to communicate over the Internet via shortwaves on an existing Ham Radio Network.

9. The system according to claim 1, wherein the user device is a mobile device.

10. (canceled)

11. The system according to claim 8, further comprising a charger and an antenna connected to the computing device.

12. The system according to claim 8, wherein the computing device and the base station have security software loaded on them to enable a community-of-interest to include the base station and the computing device.

13. The system according to claim 12, wherein the user device has security software loaded on it to enable it to be a part of the community-of-interest.

14. The system according to claim 12, wherein the security software is Stealth.

15. A computer implemented method of establishing communications between an user device and the Internet, the method comprising:
establishing, by a processor of a portable shortwave TCP/IP transceiver, communication with a base station via shortwaves;
establishing, by a processor of a user device, communication with the portable shortwave TCP/IP transceiver via WIFI TCP/IP;
wherein, a user of an user device is able to use a portable shortwave TCP/IP transceiver to communicate over the Internet via shortwaves on an existing Ham Radio Network.

16. The method according to claim 15, wherein establishing communication includes the user device being a mobile device.

17. (canceled)

18. The method according to claim 8, further comprising:
defining a community-of-interest to include the portable shortwave TCP/IP transceiver and the base station.

19. The method according to claim 18, wherein defining includes defining a community-of-interest to include the user device.

20. The method according to claim 19, wherein defining includes using Stealth to define a community-of-interest.
